(19) United States
(12) Patent Application Publication
(10) Pub. No.: US 2005/0286482 A1
(43) Pub. Date: Dec. 29, 2005

(54) Apparatus and method for supporting OFDM operation in a CDMA2000 wireless network

(75) Inventor: Purva R. Rajkotia, Plano, TX (US)

Correspondence Address: DOCKET CLERK, P.O. DRAWER 800889, DALLAS, TX, 75380, US

(73) Assignee: SAMSUNG ELECTRONICS CO., LTD., Suwon-city (KR)

(21) Appl. No.: 11/108,184

(22) Filed: Apr. 18, 2005

Related U.S. Application Data
(60) Provisional application No. 60/583,551, filed on Jun. 28, 2004.

(51) Int. Cl. H04B 7/216

(52) U.S. Cl. 370/342; 370/203

(57) ABSTRACT

An apparatus and method for supporting OFDM operation in a CDMA2000 wireless network, including a base station and mobile station capable of supporting OFDM symbols within a CDMA signal structure.

### TECHNICAL FIELD OF THE INVENTION

The present invention relates generally to wireless networks and, more specifically, to base stations and mobile stations that support OFDM operation in a CDMA2000 wireless network.

### BACKGROUND OF THE INVENTION

Code-division multiple access (CDMA) is a coding scheme, used as a modulation technique, in which multiple channels are independently coded for transmission over a single wideband channel. In some communication systems, CDMA is used as an access method that permits carriers from different stations to use the same transmission equipment by using a wider bandwidth than the individual carriers. On reception, each carrier can be distinguished from the others by means of a specific modulation code, thereby allowing for the reception of signals that were originally overlapping in frequency and time. Thus, several transmissions can occur simultaneously within the same bandwidth, with the mutual interference reduced by the degree of orthogonality of the unique codes used in each transmission. CDMA permits a more uniform distribution of energy in the emitted bandwidth.

CDMA2000, also known as IMT-CDMA Multi-Carrier or 1xRTT, is a code-division multiple access (CDMA) version of the IMT-2000 standard developed by the International Telecommunication Union (ITU). The CDMA2000 standard is third-generation (3-G) mobile wireless technology.

CDMA2000 can support mobile data communications at speeds ranging from 144 Kbps to 2 Mbps. As of mid-2003, the CDMA Development Group reported that more than 50 CDMA2000 networks have been deployed.

Orthogonal frequency-division multiplexing (OFDM) is a method of digital modulation in which a signal is split into several narrowband channels at different frequencies. The technology was first conceived in the 1960s and 1970s during research into minimizing interference among channels near each other in frequency.

In some respects, OFDM is similar to conventional frequency-division multiplexing (FDM). The difference lies in the way in which the signals are modulated and demodulated. Priority is given to minimizing the interference, or crosstalk, among the channels and symbols comprising the data stream. Less importance is placed on perfecting individual channels.

Both CDMA and OFDM have advantages, but current technology uses different wireless network infrastructure for these two systems. One possible solution proposed, that combines some CDMA and OFDM techniques, is multi-carrier code division multiple access (MC-CDMA), as described in “Multi Carrier Code Division Multiple Access” (Hughes Software Systems white paper, March 2002), and “Analysis of Extended OFDM-CDMA System” (Balog, Balazs, et. al, August 2001), both of which are hereby incorporated by reference. MC-CDMA uses orthogonal spreading code sequences in the frequency domain to achieve a form of frequency diversity, but does not efficiently utilize the existing CDMA infrastructure.

Therefore, there is a need in the art for an apparatus and method for supporting OFDM operation in a CDMA wireless network, and particularly in a CDMA 2000 wireless network.

### SUMMARY OF THE INVENTION

To address the above-discussed deficiencies of the prior art, it is a primary object of the present invention to provide an apparatus and method for supporting OFDM operation in a CDMA2000 wireless network.

One embodiment includes, for use in a wireless network, a base station capable of transmitting orthogonal frequency division multiplexed (OFDM) symbols in a code division multiple access (CDMA) system, said base station comprising first control means for controlling CDMA pilot channel data; second control means for encoding and decoding OFDM symbols; and a radio-frequency transmitter for transmitting the CDMA pilot channel data on a CDMA pilot channel and for transmitting the OFDM symbols on a second CDMA channel.

Another embodiment includes, for use in a wireless network, a mobile station capable of receiving orthogonal frequency division multiplexed (OFDM) symbols in a code division multiple access (CDMA) system, said mobile terminal comprising first control means for receiving CDMA pilot channel data; second control means for encoding and decoding OFDM symbols; and a radio-frequency transceiver for receiving the CDMA pilot channel data on a CDMA pilot channel and for receiving the OFDM symbols on a second CDMA channel.

Another embodiment includes a method for communications in a wireless network having a base station capable of transmitting orthogonal frequency division multiplexed (OFDM) symbols in a code division multiple access (CDMA) system: transmitting CDMA pilot channel data on a CDMA pilot channel; and transmitting OFDM symbols on a second CDMA channel.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present invention and its advantages, reference is now made to the following description taken in conjunction with the accompanying drawings, in which like reference numerals represent like parts:

FIG. 1 illustrates an exemplary wireless network that supports orthogonal frequency division multiplexing (OFDMA) operation according to the principles of the present invention;

FIG. 2 illustrates an exemplary base station that supports orthogonal frequency division multiplexing (OFDMA) operation according to the principles of the present invention;

FIG. 3 illustrates wireless mobile station that supports orthogonal frequency division multiplexing (OFDMA) according to an exemplary embodiment of the present invention;

FIGS. 4A-4C illustrate transmissions on the pilot channel and forward broadcast supplemental channel (F-BSCH) according to an exemplary embodiment of the present invention; and

FIG. 5 illustrates transmissions on the pilot channel and forward broadcast supplemental channel (F-BSCH) according to an exemplary embodiment of the present invention.

### DETAILED DESCRIPTION OF THE INVENTION

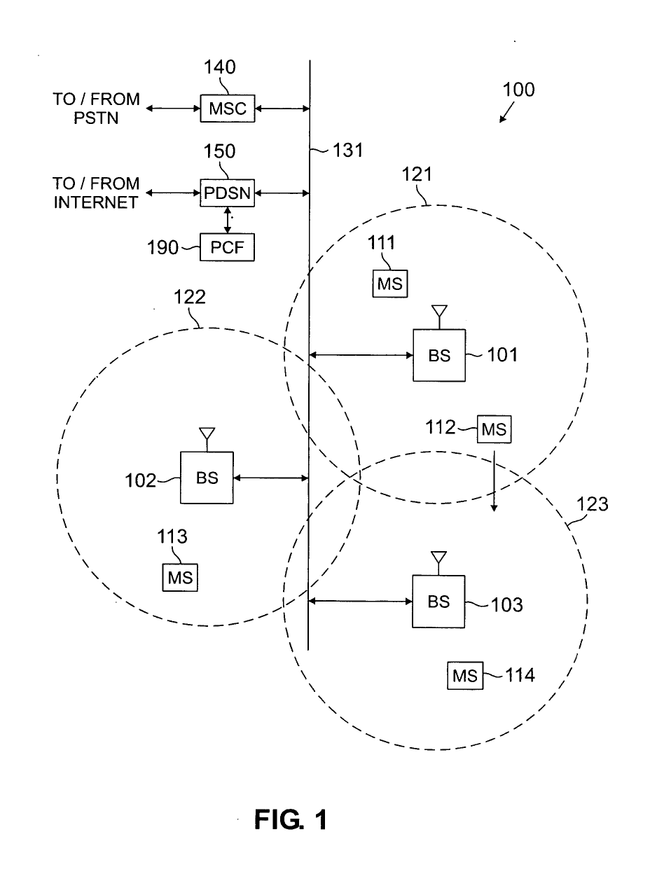

FIGS. 1 through 5, discussed below, and the various embodiments used to describe the principles of the present invention in this patent document are by way of illustration only and should not be construed in any way to limit the scope of the invention. Those skilled in the art will understand that the principles of the present invention may be implemented in any suitably arranged wireless network.

Preferred embodiments of the present invention include techniques to support OFDM on the Broadcast Multicast services on CDMA2000 systems. OFDM technology is be well suited for delivering some broadcast kind of services, as the group of base stations in the broadcast group might be transmitting the same data. The transmission of the same data, from all the base stations with in the same group reduces the sub-carrier interference.

Currently, in CDMA2000, the broadcast multicast services are supported on the forward broadcast supplemental channel (F-BSCH). In a typical CDMA2000 system the F-BSCH channel is a one-way, high-rate communication link to a large number of mobile stations. Various disclosed embodiments include supporting the broadcast services using OFDM symbols on the F-BSCH on a different carrier frequency as the one on which voice and data traffic are being transmitted to reduce the overall interference. Other embodiments include alternating CDMA and OFDM transmissions within the same frequency band. Various embodiments also include some modifications to the overhead channel structure, without breaking the backwards compatibility.

In the current CDMA2000 specifications, the pilot is a continuous streamed channel. The problem with having a continuous streamed pilot for technologies like OFDM is the amount of interference created. OFDM systems are not generally resilient to the interference created within the sector. CDMA systems generally perform better compared to OFDM/OFDMA when the interference is high.

According to some disclosed embodiments, to reduce the interference by pilot, the pilot channel is time-division multiplexed. In these embodiments, the pilot channel transmission is only made when the OFDM symbols are not being transmitted on the F-BSCH channel. The duration of the transmission of pilot channel is a dynamic and configurable parameter, controlled by the base station.

The channel structure of the sync and paging channel is not changed. The power requirements of the sync and paging channel has to be reduced from its present level to reduce the interference in the cell.

The structure of the forward broadcast supplemental channel also remains the same for backwards compatibility with the legacy systems.

FIG. 1 illustrates exemplary wireless network 100, which supports orthogonal frequency division multiplexing (OFDMA) operation according to the principles of the present invention. Wireless network 100 comprises a plurality of cell sites 121-123, each containing one of the base stations, BS 101, BS 102, or BS 103. Base stations 101-103 communicate with a plurality of mobile stations (MS) 111-114 over code division multiple access (CDMA) channels according to, for example, the IS-2000 standard (i.e., CDMA2000). In an advantageous embodiment of the present invention, mobile stations 111-114 are capable of receiving data traffic and/or voice traffic on two or more CDMA channels simultaneously. Mobile stations 111-114 may be any suitable wireless devices (e.g., conventional cell phones, PCS handsets, personal digital assistant (PDA) handsets, portable computers, telemetry devices) that are capable of communicating with base stations 101-103 via wireless links.

The present invention is not limited to mobile devices. The present invention also encompasses other types of wireless access terminals, including fixed wireless terminals. For the sake of simplicity, only mobile stations are shown and discussed hereafter. However, it should be understood that the use of the term “mobile station” in the claims and in the description below is intended to encompass both truly mobile devices (e.g., cell phones, wireless laptops) and stationary wireless terminals (e.g., a machine monitor with wireless capability).

Dotted lines show the approximate boundaries of cell sites 121-123 in which base stations 101-103 are located. The cell sites are shown approximately circular for the purposes of illustration and explanation only. It should be clearly understood that the cell sites may have other irregular shapes, depending on the cell configuration selected and natural and man-made obstructions.

As is well known in the art, each of cell sites 121-123 is comprised of a plurality of sectors, where a directional antenna coupled to the base station illuminates each sector. The embodiment of FIG. 1 illustrates the base station in the center of the cell. Alternate embodiments may position the directional antennas in corners of the sectors. The system of the present invention is not limited to any particular cell site configuration.

In one embodiment of the present invention, each of BS 101, BS 102 and BS 103 comprises a base station controller (BSC) and one or more base transceiver subsystem(s) (BTS). Base station controllers and base transceiver subsystems are well known to those skilled in the art. A base station controller is a device that manages wireless communications resources, including the base transceiver subsystems, for specified cells within a wireless communications network. A base transceiver subsystem comprises the RF transceivers, antennas, and other electrical equipment located in each cell site. This equipment may include air conditioning units, heating units, electrical supplies, telephone line interfaces and RF transmitters and RF receivers. For the purpose of simplicity and clarity in explaining the operation of the present invention, the base transceiver subsystems in each of cells 121, 122 and 123 and the base station controller associated with each base transceiver subsystem are collectively represented by BS 101, BS 102 and BS 103, respectively.

BS 101, BS 102 and BS 103 transfer voice and data signals between each other and the public switched telephone network (PSTN) (not shown) via communication line 131 and mobile switching center (MSC) 140. BS 101, BS 102 and BS 103 also transfer data signals, such as packet data, with the Internet (not shown) via communication line 131 and packet data server node (PDSN) 150. Packet control function (PCF) unit 190 controls the flow of data packets between base stations 101-103 and PDSN 150. PCF unit 190 may be implemented as part of PDSN 150, as part of MSC 140, or as a stand-alone device that communicates with PDSN 150, as shown in FIG. 1. Line 131 also provides the connection path for control signals transmitted between MSC 140 and BS 101, BS 102 and BS 103 that establish connections for voice and data circuits between MSC 140 and BS 101, BS 102 and BS 103.

Communication line 131 may be any suitable connection means, including a T1 line, a T3 line, a fiber optic link, a network packet data backbone connection, or any other type of data connection. Line 131 links each vocoder in the BSC with switch elements in MSC 140. The connections on line 131 may transmit analog voice signals or digital voice signals in pulse code modulated (PCM) format, Internet Protocol (IP) format, asynchronous transfer mode (ATM) format, or the like.

MSC 140 is a switching device that provides services and coordination between the subscribers in a wireless network and external networks, such as the PSTN or Internet. MSC 140 is well known to those skilled in the art. In some embodiments of the present invention, communications line 131 may be several different data links where each data link couples one of BS 101, BS 102, or BS 103 to MSC 140.

In the exemplary wireless network 100, MS 111 is located in cell site 121 and is in communication with BS 101. MS 113 is located in cell site 122 and is in communication with BS 102. MS 114 is located in cell site 123 and is in communication with BS 103. MS 112 is also located close to the edge of cell site 123 and is moving in the direction of cell site 123, as indicated by the direction arrow proximate MS 112. At some point, as MS 112 moves into cell site 123 and out of cell site 121, a hand-off will occur.

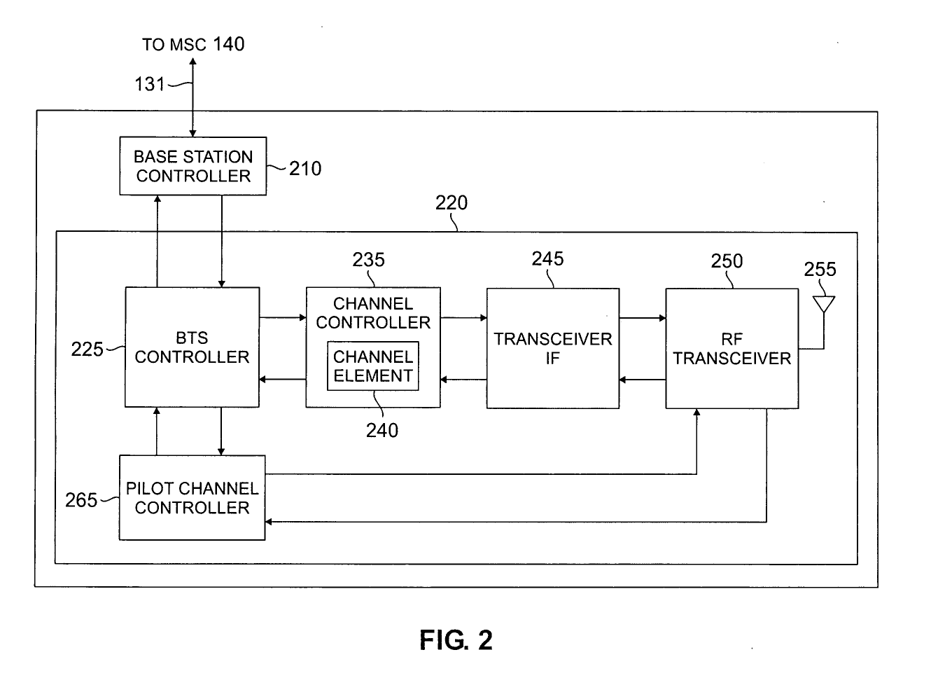

FIG. 2 illustrates exemplary base station 101, which supports orthogonal frequency division multiplexing (OFDMA) operation according to the principles of the embodiments disclosed herein. Base station 101 comprises base station controller (BSC) 210 and base transceiver station (BTS) 220. Base station controllers and base transceiver stations were described previously in connection with FIG. 1. BSC 210 manages the resources in cell site 121, including BTS 220. BTS 120 comprises BTS controller 225, channel controller 235 (which contains representative channel element 240), transceiver interface (IF) 245, RF transceiver 250, and antenna array 255.

BTS controller 225 comprises processing circuitry and memory capable of executing an operating program that controls the overall operation of BTS 220 and communicates with BSC 210. Under normal conditions, BTS controller 225 directs the operation of channel controller 235, which contains a number of channel elements, including channel element 240, that perform bi-directional communications in the forward channel and the reverse channel. A “forward” channel refers to outbound signals from the base station to the mobile station and a “reverse” channel refers to inbound signals from the mobile station to the base station. IN particular, channel controller 235 contains elements for sending at least a forward broadcast supplemental channel. Transceiver IF 245 transfers the bi-directional channel signals between channel controller 240 and RF transceiver 250.

Antenna array 255 transmits forward channel signals received from RF transceiver 250 to mobile stations in the coverage area of BS 101. Antenna array 255 also sends to RF transceiver 250 reverse channel signals received from mobile stations in the coverage area of BS 101. In a preferred embodiment of the present invention, antenna array 255 is multi-sector antenna, such as a three-sector antenna in which each antenna sector is responsible for transmitting and receiving in a 120° arc of coverage area. Additionally, RF transceiver 250 may contain an antenna selection unit to select among different antennas in antenna array 255 during both transmit and receive operations.

BTS 220 also includes pilot channel controller 265, which is connected to BTS controller 225 and RF transceiver 250 to control the pilot channel data transmissions, as described herein with respect to at least some embodiments.

In preferred embodiments, RF transceiver 250 is a dual mode RF transceiver, capable of communicating using CDMA and OFDM techniques, and in particular using the combined CDMA/OFDM techniques described herein.

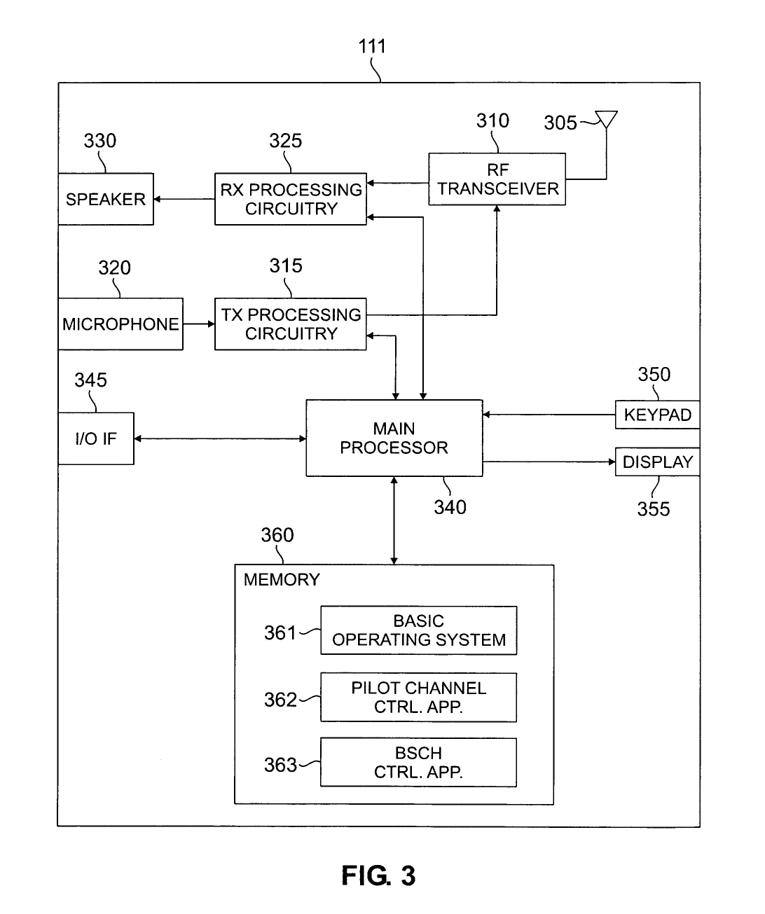

FIG. 3 illustrates wireless mobile station 111, which supports orthogonal frequency division multiplexing (OFDMA) operation according to the principles of the present invention. Wireless mobile station 111 comprises antenna 305, radio frequency (RF) transceiver 310, transmit (TX) processing circuitry 315, microphone 320, and receive (RX) processing circuitry 325. MS 111 also comprises speaker 330, main processor 340, input/output (I/O) interface (IF) 345, keypad 350, display 355, and memory 360. Memory 360 further comprises basic operating system (OS) program 361.

Radio frequency (RF) transceiver 310 receives from antenna 305 an incoming RF signal transmitted by a base station of wireless network 100. Radio frequency (RF) transceiver 310 down-converts the incoming RF signal to produce an intermediate frequency (IF) or a baseband signal. The IF or baseband signal is sent to receiver (RX) processing circuitry 325 that produces a processed baseband signal by filtering, decoding, and/or digitizing the baseband or IF signal. Receiver (RX) processing circuitry 325 transmits the processed baseband signal to speaker 330 (i.e., voice data) or to main processor 340 for further processing (e.g., web browsing).

In preferred embodiments, RF transceiver 310 is a dual mode RF transceiver, capable of communicating using CDMA and OFDM techniques, and in particular using the combined CDMA/OFDM techniques described herein.

Transmitter (TX) processing circuitry 315 receives analog or digital voice data from microphone 320 or other outgoing baseband data (e.g., web data, e-mail, interactive video game data) from main processor 340. Transmitter (TX) processing circuitry 315 encodes, multiplexes, and/or digitizes the outgoing baseband data to produce a processed baseband or IF signal. Radio frequency (RF) transceiver 310 receives the outgoing processed baseband or IF signal from transmitter (TX) processing circuitry 315. Radio frequency (RF) transceiver 310 up-converts the baseband or IF signal to a radio frequency (RF) signal that is transmitted via antenna 305.

In an advantageous embodiment of the present invention, main processor 340 is a microprocessor or microcontroller. Memory 360 is coupled to main processor 340. According to an advantageous embodiment of the present invention, part of memory 360 comprises a random access memory (RAM) and another part of memory 360 comprises a Flash memory, which acts as a read-only memory (ROM).

Main processor 340 executes basic operating system (OS) program 361 stored in memory 360 in order to control the overall operation of wireless mobile station 111. In one such operation, main processor 340 controls the reception of forward channel signals and the transmission of reverse channel signals by radio frequency (RF) transceiver 310, receiver (RX) processing circuitry 325, and transmitter (TX) processing circuitry 315, in accordance with well-known principles. Memory 360 also includes, in preferred embodiments, a pilot channel control application 362, used by main processor 340 to control the transmission and reception of pilot channel data, and broadcast services channel (BSCH) control application 363, used by main processor 340 to control the transmission and reception of data on the BSCH.

Main processor 340 is capable of executing other processes and programs resident in memory 360. Main processor 340 can move data into or out of memory 360, as required by an executing process. Main processor 340 is also coupled to I/O interface 345. I/O interface 345 provides mobile station 111 with the ability to connect to other devices such as laptop computers and handheld computers. I/O interface 345 is the communication path between these accessories and main controller 340.

Main processor 340 is also coupled to keypad 350 and display unit 355. The operator of mobile station 111 uses keypad 350 to enter data into mobile station 111. Display 355 may be a liquid crystal display capable of rendering text and/or at least limited graphics from web sites. Alternate embodiments may use other types of displays.

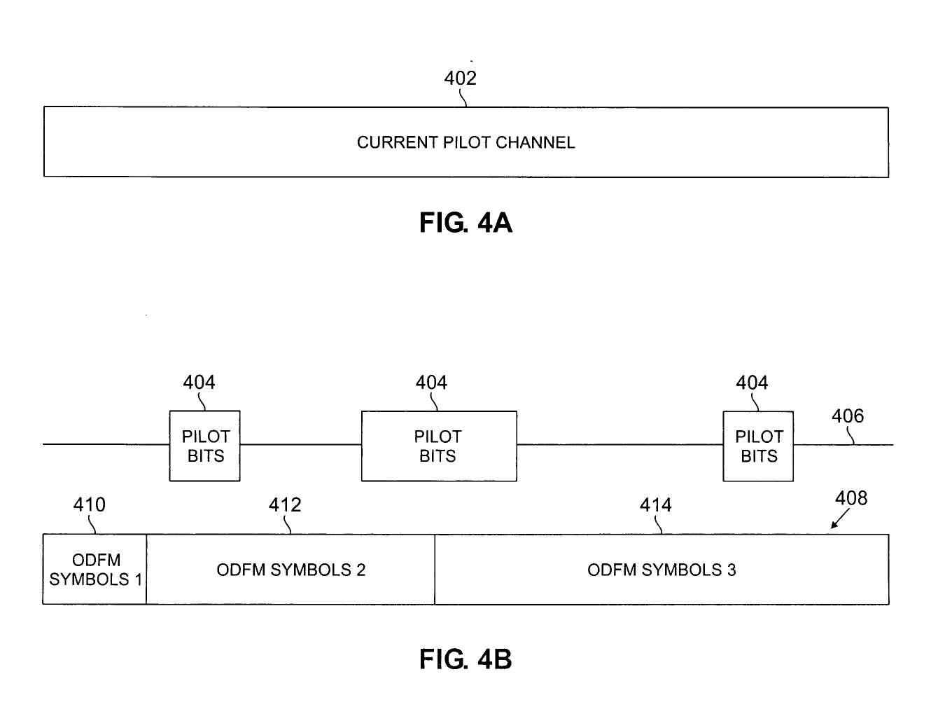

FIGS. 4A-4C illustrate transmissions on the pilot channel and forward broadcast supplemental channel (F-BSCH) in accordance with a preferred embodiment.

FIG. 4A shows a conventional pilot channel 402. Here, the pilot channel 402 is in continuous use, as shown.

FIG. 4B shows pilot channel 406 and F-BSCH channel 408 in accordance with a preferred embodiment using a first disclosed technique for supporting OFDM operation in a CDMA2000 wireless network. According to this technique, pilot channel 406 and F-BSCH channel 408 alternate in the same frequency band F1, preferably on a 1.25 MHz carrier. Here, pilot channel 406 intermittently transmits pilot bits 404 in CDMA mode. The duration of the transmission of pilot bits 404 is a dynamic and configurable parameter, controlled by the base station.

In one embodiment, a burst of pilot bits 404 has a duration of 1.25-500 milliseconds. In heavy traffic, a burst of pilot bits will be transmitted every 2-3 seconds.

F-BSCH channel 408 is used to transmit OFDM symbols, shown here as OFDM symbols-1 410, OFDM symbols-2 412, and OFDM symbols-3 414, in OFDM mode. Of course, in practice, there will many OFDM symbol sets. In some embodiments, a variable data rate is supported on the F-BSCH channel 408; in this way, different sets of OFDM symbols can be supported on the F-BSCH channel 408.

Preferably, the symbols generated for the OFDM symbols can be adaptively modulated, e.g., 16-QAM, QPSK, BPSK, and other known encoding methods, dependent on the duration of the OFDM symbols 410/412/414 being transmitted on the F-BSCH channel 408.

FIG. 4C illustrates the interaction between the pilot channel 406 and the F-BSCH channel 408, in accordance with some embodiments. As may be seen the transmission of pilot bits 404 is only made when the OFDM symbols 410/412/414 are not being transmitted on the F-BSCH channel 408.

TABLE 1 illustrates the OFDM symbols format for the transmission on the F-BSCH channel according to an exemplary embodiment of the present invention.

TABLE 1

| Parameter | Value |
|---|---|
| Number of Tones in OFDM block (NBlock) | 320-4096 |
| Cyclic Prefix Length (Nc) | NBlock/4 |
| Number of Pilot Tones | Spaced every 4-8 tones |
| Number of Data Symbols per Block | NBlock-Nc |
| Number of Guard Tones (Ng) | 20-100 |

In some embodiments, the transmission of the OFDM parameters are be conveyed to the MS by using the BSPM (Broadcast Service Parameters Message). The BSPM includes the TDM duration of the pilot channel, the TDM duration of the F-BSCH, and the OFDM symbols format. Alternately, these parameters can be sent as in-traffic system parameter messages (IT-SPM).

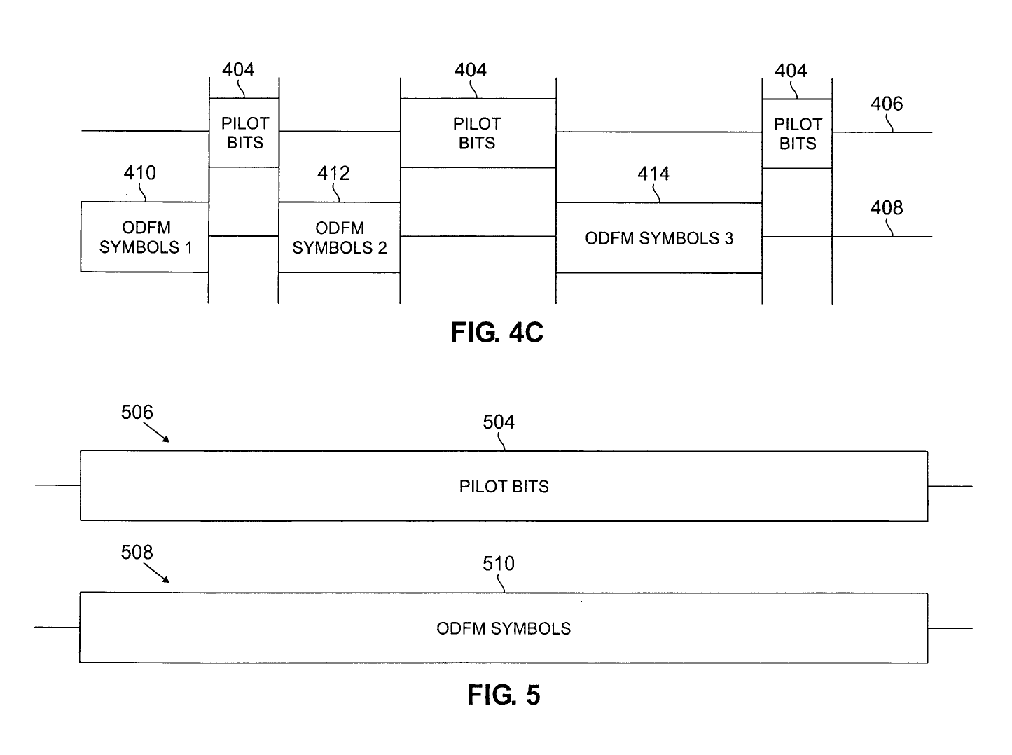

FIG. 5 illustrates transmissions on the pilot channel and forward broadcast supplemental channel (F-BSCH) in accordance with another embodiment. FIG. 5 shows pilot channel 506 and F-BSCH channel 508 in accordance with a preferred embodiment using a second disclosed technique for supporting OFDM operation in a CDMA2000 wireless network.

According to this technique, pilot channel 506 operates continuously in CDMA mode in a first frequency band F1, transmitting a generally continuous stream of pilot bits 504. F-BSCH channel 508 operates in OFDM mode, transmitting a generally continuous stream of OFDM symbols 510 in a second frequency band F2.

Although the present invention has been described with an exemplary embodiment, various changes and modifications may be suggested to one skilled in the art. It is intended that the present invention encompass such changes and modifications as fall within the scope of the appended claims.

1. For use in a wireless network, a base station capable of transmitting orthogonal frequency division multiplexed (OFDM) symbols in a code division multiple access (CDMA) system, said base station comprising:
first control means for controlling CDMA pilot channel data;
second control means for encoding and decoding OFDM symbols; and
a radio-frequency transmitter for transmitting the CDMA pilot channel data on a CDMA pilot channel and for transmitting the OFDM symbols on a second CDMA channel.

2. The base station as set forth in claim 1, wherein the CDMA pilot channel and the second CDMA channel operate in different frequency bands.

3. The base station as set forth in claim 1, wherein the CDMA pilot channel and the second CDMA channel operate in the same frequency band, and wherein the CDMA pilot channel and the second CDMA channel do not transmit at the same time.

4. The base station as set forth in claim 1, wherein the second CDMA channel is a CDMA forward broadcast supplemental channel.

5. The base station as set forth in claim 1, wherein the CDMA pilot channel data is transmitted in bursts no more than three seconds apart.

6. The base station as set forth in claim 1, wherein the radio-frequency transmitter is further operable to transmit OFDM parameters using a CDMA broadcast service parameters message.

7. The base station as set forth in claim 1, wherein the radio-frequency transmitter is further operable to transmit OFDM parameters using in-traffic system parameter messages.

8. For use in a wireless network, a mobile station capable of receiving orthogonal frequency division multiplexed (OFDM) symbols in a code division multiple access (CDMA) system, said mobile terminal comprising:
first control means for receiving CDMA pilot channel data;
second control means for encoding and decoding OFDM symbols; and
a radio-frequency transceiver for receiving the CDMA pilot channel data on a CDMA pilot channel and for receiving the OFDM symbols on a second CDMA channel.

9. The mobile station as set forth in claim 8, wherein the CDMA pilot channel and the second CDMA channel operate in different frequency bands.

10. The mobile station as set forth in claim 8, wherein the CDMA pilot channel and the second CDMA channel operate in the same frequency band, and wherein the CDMA pilot channel and the second CDMA channel do not transmit at the same time.

11. The mobile station as set forth in claim 8, wherein the second CDMA channel is a CDMA forward broadcast supplemental channel.

12. The mobile station as set forth in claim 8, wherein the CDMA pilot channel data is transmitted in bursts no more than three seconds apart.

13. The mobile station as set forth in claim 8, wherein the radio-frequency transceiver is further operable to receive OFDM parameters in a CDMA broadcast service parameters message.

14. The mobile station as set forth in claim 8, wherein the radio-frequency transceiver is further operable to receive OFDM parameters in in-traffic system parameter messages.

15. A method for communications in a wireless network having a base station capable of transmitting orthogonal frequency division multiplexed (OFDM) symbols in a code division multiple access (CDMA) system:
transmitting CDMA pilot channel data on a CDMA pilot channel; and
transmitting OFDM symbols on a second CDMA channel.

16. The method as set forth in claim 15, wherein the CDMA pilot channel and the second CDMA channel operate in different frequency bands.

17. The method as set forth in claim 15, wherein the CDMA pilot channel and the second CDMA channel operate in the same frequency band, and wherein the transmitting CDMA pilot channel data and the transmitting OFDM symbols do not occur at the same time.

18. The method as set forth in claim 15, wherein the second CDMA channel is a CDMA forward broadcast supplemental channel.

19. The method as set forth in claim 15, wherein the CDMA pilot channel data is transmitted in bursts no more than three seconds apart.

20. The method as set forth in claim 15, further comprising transmitting OFDM parameters using a CDMA broadcast service parameters message.
